(19) United States
(12) Patent Application Publication
(10) Pub. No.: US 2006/0156418 A1
(43) Pub. Date: Jul. 13, 2006

(54) Method and apparatus for preventing unauthorized access to data

(75) Inventor: Alexandre Polozoff, Chicago, IL (US)

Correspondence Address: MARK P. KAHLER, 8101 VAILVIEW COVE, AUSTIN, TX, 78750, US

(73) Assignee: IBM Corporation, Austin, TX (US)

(21) Appl. No.: 11/032,241

(22) Filed: Jan. 10, 2005

(51) Int. Cl. H04L 9/32; G06F 12/14; G06F 17/30; G06F 7/04; G06F 11/30; G06K 9/00; H03M 1/68; H04K 1/00; H04L 9/00; H04N 7/16

(52) U.S. Cl. 726/28; 713/193

(57) ABSTRACT

A client server network system is disclosed that protects memory data objects from being viewed by those other than a verified user. Original application code in a server is modified to intercept calls to an original class object via a secure proxy that is injected or weaved into the original application code. The secure proxy verifies that the user generating the request for the original class object is authorized to access that object. If the user is so verified, the secured proxy encrypts the requested class object. Should an unverified user somehow access the encrypted class object, such a user would be provided with scrambled information. However, if the user making the request for the class object is a verified user, the class object is decrypted and information from the decrypted class object is transmitted to the verified user.

### TECHNICAL FIELD OF THE INVENTION

The disclosures herein relate generally to the processing of requests for information and, more particularly, to processing such requests in a manner that lessens the likelihood that unauthorized users will be able to view information they are not authorized to access.

### BACKGROUND

Networked systems continue to grow and proliferate. This is especially true for networked systems such as web servers and application servers that are attached to the Internet. These server systems are frequently called upon to serve up vast quantities of information in response to very large numbers of user requests.

Servers frequently store general information that is intended for access by any user. Servers also frequently store sensitive information to which only particular users should have access. For example, when a user performs an on-line transaction with his or her bank, the account holder user should have access to that user's sensitive account information while other users should not. Many organizations have hundreds of existing applications that handle sensitive user information. Unfortunately, there have been instances where programmer error in coding an application has resulted in the occasional ability of one user being able to access another user's information without being authorized to do so. These problems have even been observed when one user is not attempting to access another user's information or data. For example, this problem has been observed when application code is caching user related data in a cache memory that is managed by the application. In these instances, the problem is typically that the application code fails to properly manage access to data by different users, thus allowing one user to see another user's data that is stored in cache memory.

One straightforward solution to the problem is to identify the offending programs and then recode these programs to be more secure. Unfortunately, this may not be feasible or practical for several reasons. For example, recoding may be extremely expensive and/or hinder time to market. In other cases, the offending applications may have been written by third parties who are not available, or who are otherwise not inclined, to recode the applications.

What is needed is a method and apparatus for accessing sensitive data which lessens the likelihood of one user seeing another user's sensitive information when not authorized to do so.

### SUMMARY

Accordingly, in one embodiment, a method is disclosed for controlling access to information in a server system. The method includes storing original application code in a server system including a shared resource. The method also includes modifying the original application code to intercept user requests for a memory object derived from information in the shared resource, thus providing modified code. The method further includes receiving a user request for access to the memory object and verifying that the user request is from a user with authority to access the memory object. The method still further includes accessing and encrypting the memory object requested by the user request if the user is verified. If kjthe user is a verified user, the encrypted object is decrypted and information contained in the decrypted object is sent to the user making the request for the memory object. In this manner, should an unverified user see the memory object, such user will not see the information contained therein because the object is encrypted. In contrast, the verified user is provided information from the decrypted version of the object.

In another embodiment, a server apparatus is disclosed that includes a storage that stores original application code and modified application code. The original application code is modified to intercept user requests for a memory object derived from information in a shared resource. Modified application code is thus provided which is capable of receiving a user request for access to the memory object. The modified code verifies that the user request is from a user with authority to access the memory object. The modified code also accesses and encrypts the memory object requested by the user request if the user is verified. Moreover, if the user is verified, the encrypted object is decrypted and information therefrom is provided to the verified user.

### BRIEF DESCRIPTION OF THE DRAWINGS

The appended drawings illustrate only exemplary embodiments of the invention and therefore do not limit its scope because the inventive concepts lend themselves to other equally effective embodiments.

FIG. 1 is a block diagram of one embodiment of the disclosed network system.

FIG. 2 is a flowchart which depicts a client process that facilitates user verification by the application server.

FIG. 3 is a flowchart depicting process flow in the application server of the disclosed network system when the server is setting data in response to a user request.

FIG. 4 is a flowchart depicting process flow in the application server of the disclosed network system when the user is getting data from the application server in response to a user request.

### DETAILED DESCRIPTION

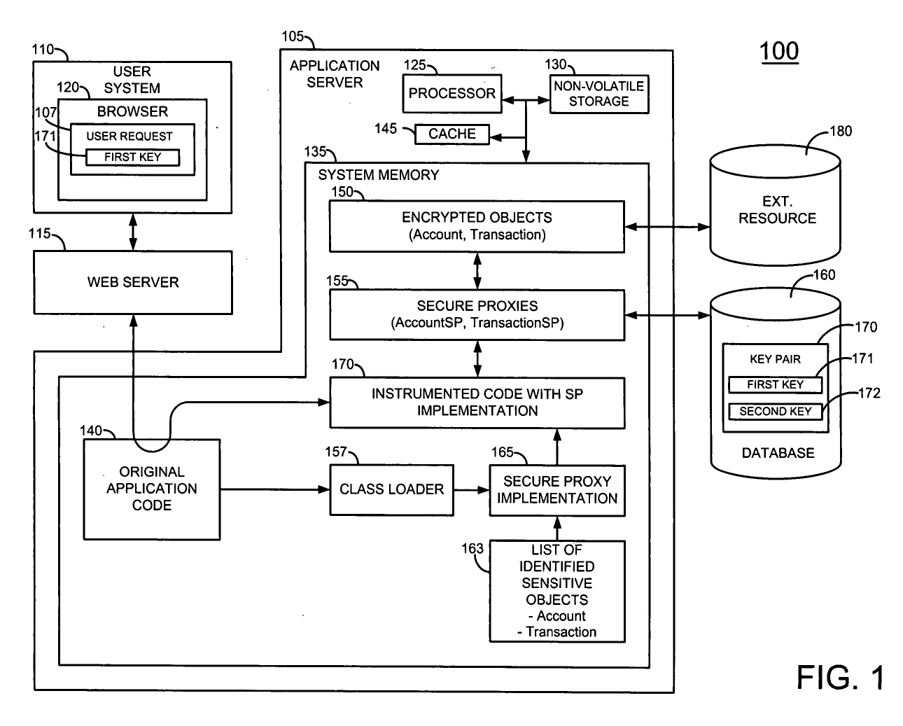

FIG. 1 is a block diagram of one embodiment of the disclosed network system 100. In this example, a user desires to access sensitive information stored in an application server 105. A user request 107 for sensitive information originates from a user information handling system (user system) 110, such as a computer, data terminal, laptop/notebook computer, personal data assistant (PDA) or other information handling device. The user system 110 is coupled to application server 105 via network infrastructure between user system 110 and application server 105. In one embodiment, an Internet-connected web server 115 couples the user system 110 to application server 105. Web server 115 relays requests for information from user system 110 to application server 105. User system 110 includes browser software 120 from which requests for information are initiated.

Application server 105 includes a processor 125 that is coupled to non-volatile storage 130 and system memory 135. FIG. 1 shows a representation of system memory 135 after programs stored in non-volatile storage 130 are loaded into system memory 135 for execution. System memory 135 includes original application code 140. For purposes of this example, original application code 140 is any program that may have a problem with an unauthorized user potentially accessing sensitive information associated with another user. In one scenario, this sensitive information may inadvertently be left in system memory 135 or cache memory 145 after an authorized user has accessed his or her sensitive information. In one embodiment, original application code 140 is aspect-oriented programming (AOP) code. AOP code is a type of code that permits additional code to be injected into the AOP code after the AOP code has been written. This alters the functionality of the AOP code without rewriting the AOP code. One language that supports AOP is Java (Java is a trademark of Sun Microsystems, Inc.).

The code that will be injected into original application code 140 is code that modifies application code 140 to intercept user requests for sensitive objects that are stored by application server 105. As will be discussed below in more detail, when a registered user attempts to access a memory object, the requested memory object is accessed and encrypted by a secure proxy layer 155. Secure proxy layer 155 stores the encrypted object 150 in system memory 135 and memory cache 145. In an alternative embodiment, secure proxy layer 155 also stores encrypted object 150 in non-volatile storage 130 or database 160. In yet another embodiment, the encrypted object is held in system memory 135 and/or cache 145 as long as needed to service the current user request and is discarded after the user request is serviced. In yet another embodiment, the encrypted object is stored in an external resource 180 that provides storage separate from database 160. The secure proxy layer 155 verifies the identity of the user and, if the user is verified as being the authorized user who is entitled to access the encrypted object 150, then secure proxy layer 155 decrypts the encrypted object and transmits the decrypted object back to the authorized user.

Before such user verification can occur, the user is first registered and issued a unique identification by the organization associated with the application server 105. This unique identifier can take the form of a User ID, a User ID with password, a digital signature, or one key of a key pair that is assigned to the user. This unique identifier entitles the user to access sensitive information associated with the user of that particular unique identifier. In one scenario, a user registers with an organization, for example a bank, credit union, stock broker, human resources department, firm, government unit, non-profit or for profit business entity, or virtually any other organization or group of users who share access to a common resource, such as a database or application. The registration of a new user can be conducted in person at the organization's facility or on-line. In either scenario, the system provides the user with a unique identifier that the user later presents for verification as an authorized user of particular sensitive information.

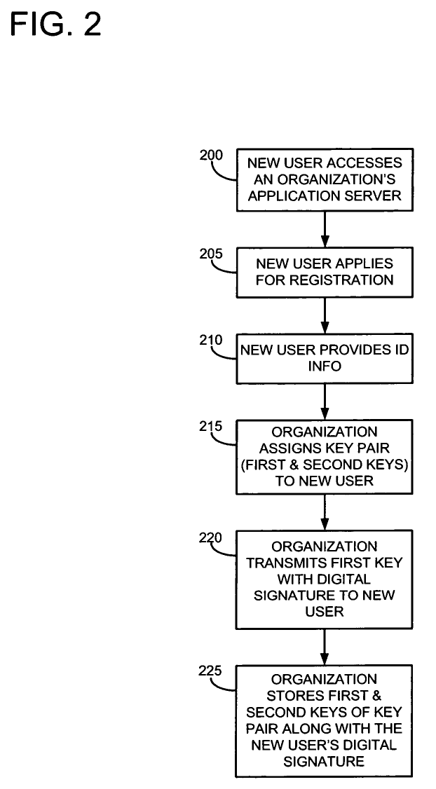

FIG. 2 is a flowchart which depicts a client process wherein user verification by application server 105 is made possible. A new user of user system 110, namely a client system of application server 105, accesses server 105 as per block 200. The new user then applies to register, namely to establish and/or use an account on application server 105 as per block 205. As per block 210, the new user transmits identification information to the organization associated with application server 105. This can be done by the network connection between user system 110 and application server 105, or may be done by the new user physically travelling to the organization, or alternatively may be conducted by mail. When the organization associated with application server 105 is satisfied that the new user is acceptable, the organization or the organization's application server 105 issues a unique identifier to the new user. Again, this can be performed either on-line, in person or via mail.

In one embodiment, the organization's application server 105 assigns a key pair 170 to the new user as per block 215. The key pair 170 includes a first key 171 and a second key 172, which are needed to respectively encrypt and decrypt memory objects that are associated with the particular user and that are stored by application server 105. Application server 105 then transmits, or otherwise supplies, the new user with the first key of the key pair as per block 220. In one embodiment, the identifier provided to the new user also includes a digital signature that acts as a unique identifier for the user. Application server 105 stores the key pair 170 and the digital signature associated with the new user in database 160 as per block 225. Application server 105 also stores a unique key pair in database 160 for each authorized user that is registered to use the application server. Application server 105 also stores association information noting which user files belong to which users, the goal being to permit one user to have access to his or her own files without being allowed access to the files of other users for which access is not authorized. The association information may be stored in database 160 along with first and second key pairs, or alternatively in non-volatile storage 130. It is noted that in an alternative embodiment, database 160 may be a part of application server 105.

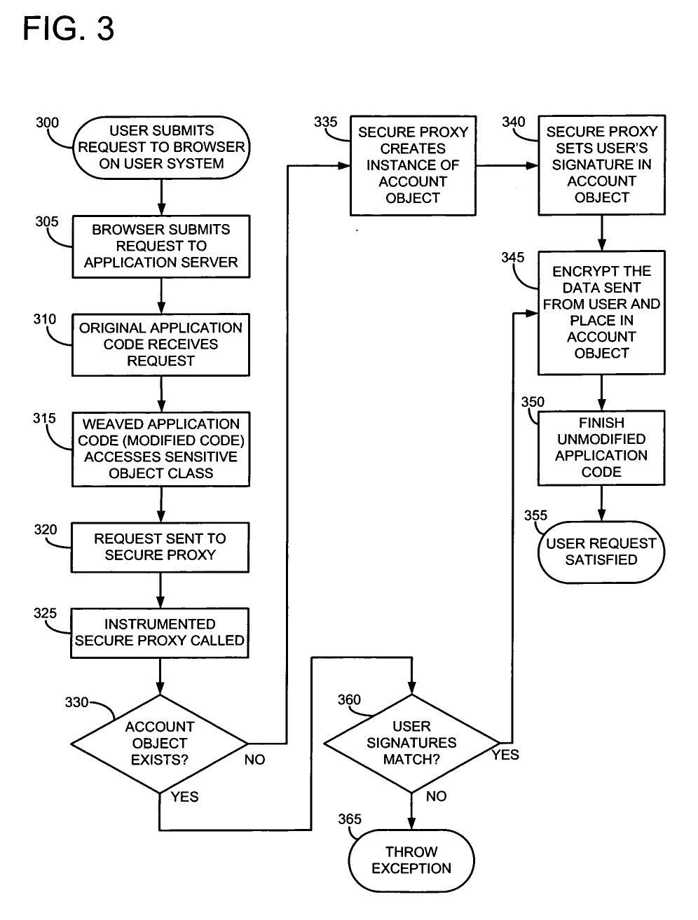

FIG. 3 is a flowchart depicting process flow in the application server 105 of the disclosed network system 100 when the server sets (i.e. writes) data or information in response to a user request. In other words, user system 110 sends data to be set in application server 105. It is assumed that application server 105 is already initialized and that an operating system has been loaded. In this particular embodiment, it is also assumed that application server 105 loads an aspect oriented programming (AOP) runtime environment or other software enabling the application server to run AOP programs. For example, application server 105 loads a run time environment such as Java™.

It is noted that when application server 105 loads original application code 140, application server 105 modifies the original application code 140 to incorporate secure proxies 155 that will intercept requests for access to identified sensitive objects 163. The secure proxy implementation code 165 includes code that modifies original application code 140 to include secure proxies 155. Class loader 157 injects the secured proxies associated with secure proxy implementation code 165 into original application code 140 when the original application code is loaded. Application server 105 modifies the original application code 140 by weaving secure proxy implementation code 165 into original application code 140 to form instrumented code with secure proxy (SP) implementation 170, namely instrumented code 170. Instrumented code 170 is thus modified code that includes secure proxies 155. In this particular example, secure proxies 155, namely AccountSP and TransactionSP, interact with encrypted objects 150, namely Account and Transaction. Secure proxies 155 intercept attempts to access encrypted objects 150 as will be discussed below in more detail.

Process flow starts at block 300 when the user submits a set request to user system 110. Browser 120 submits this request to application server 105 as per block 305. Original application code 140 receives the user request as per block 310. The modified or weaved application code, namely instrumented code with SP implementation 170, intercepts the request to set data and accesses a sensitive object class that is specified in the user request submitted to code 170, as per block 315. More specifically, application server 105 sends the request to secure proxies 155 as per block 320. Application server 105 calls an instrumented secured proxy from secure proxies 155 as per block 325 so that the intercepted request to set data or information can be handled in a secure manner as explained below.

To handle the set data to an account object request, decision block 330 first conducts a test to determine if the account object already exists. If it is determined by decision block 330 that the subject account object does not exist, then the secure proxy 155 creates an instance of the account object as per block 335. Secure proxy 155 then sets the digital signature of the user in the requested account object as per block 340. The digital signature of the user is part of the user request. While in one embodiment the digital signature of the user is set in the account object, other embodiments are possible, wherein another unique identifier associated with the particular user is set to the requested account object. For example, a user identification or user name may be employed as the unique identifier of the user. The data sent from the user in the request is then encrypted and placed in the account object 150 as per block 345. Recall that in the embodiment depicted in FIG. 1, a key pair 170 is employed including a first key 171 held by the user of user system 110, while first key 171 and second key 172 are held by database 160. For a particular user, application server 105 uses the user's first key to encrypt an object. Later, application server 105 uses the second key of the first key-second key pair to decrypt the encrypted object. Once the data from a user request is encrypted and placed in the corresponding account object, then execution of the modified code is complete and application server 105 returns to executing the remaining unmodified portion of original application code 140 as per block 350. When the remaining unmodified portion of the original application code is finished, the user request is deemed satisfied as per block 355.

Returning to decision block 330, if block 330 determines that the account object called by the user request already exists, then decision block 360 conducts a further test. Decision block 360 tests to determine if the user's digital signature that is included with user request 107 matches the user's digital signature that is stored with the account object which is the subject of the user request. This is a user identity verification test. If there is a match between the user signature of the request and the user signature already set in the account object called by the request, then process flow continues to block 345. Block 345 encrypts the data sent from the user with the request and stores the result in the subject account object in the manner already discussed above with respect to blocks 345-355. However, if the user signature of the user request fails to match the user signature of the account object that is the subject of that request, then block 365 generates an exception. In this case, the user request is not permitted to write data to the account object that is the subject of the request.

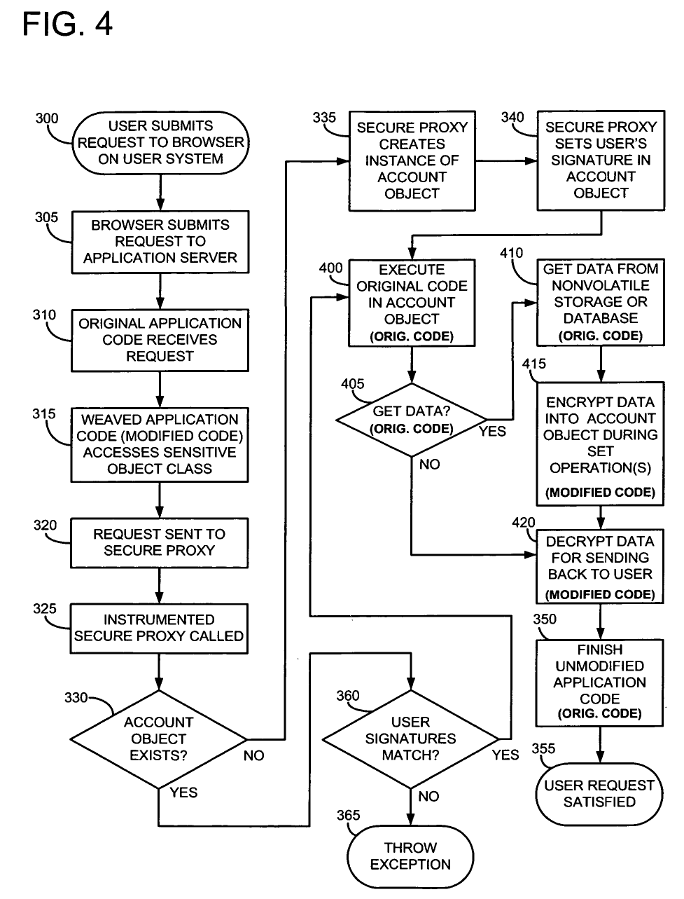

FIG. 4 is a flowchart depicting process flow in the application server 105 of the disclosed network system 100 when the user is getting, i.e. retrieving, data from the application server in response to a user request. The user request includes the digital signature or other unique identifier of the user of user system 110. The user request also includes the name of the object from which the user desires to get data from application server 105. The flowchart of FIG. 4 has elements in common with the flowchart of FIG. 3 and thus like numbers are used to indicate like elements or blocks when comparing the flowcharts of FIGS. 3 and 4. However, in FIG. 4 the user request is to get data from an object, whereas in FIG. 3 the request was to set data in an object.

Process flow with respect to the user request continues in FIG. 4 as in FIG. 3 from blocks 300 through 330, except that in FIG. 4 the user request is to get or retrieve data in the account object specified by the user request. Decision block 330 conducts a test to determine if the account object specified in the user request already exists. If decision block 330 finds that the specified account object already exists, then process flow continues to decision block 360 which conducts a test to determine if the user's digital signature in the user request matches the digital signature stored in nonvolatile storage 130 or database 160 for that particular account object specified by the request. If the signatures do not match, then block 365 generates an exception and denies the get request. However, if the signatures match, then application server 105 executes original code in the account object as per block 400. In actual practice, block 400 represents code that exists in encrypted objects 150 of FIG. 1. The original code then conducts a test at decision block 405 to determine if the user request is a get data request. If the current request is for a get data operation, then application server 105 retrieves the requested data from nonvolatile storage 130 or database 160 as per block 410 of the original code. In an alternative embodiment, application server 105 retrieves the requested data from an external resource 180, for example a database provided by a mainframe or other external resource. Application server 105 then encrypts the retrieved data into an encrypted account object 150 during the set operation as per block 415. Application server 105 uses the first user key 171 to an encrypt object 150 in this operation. This encryption occurs prior to the object being stored in cache memory 145. It should be noted that the account object referenced herein is representative of one possible implementation. The actual object may be any identified sensitive object in the list of identified sensitive objects 163 of FIG. 1. More specifically, the objects “Account” and “Transaction” of list 163 are merely representative examples. In actual practice, the list of identified sensitive account objects may include any other objects specified by the software developer or others.

As per block 420, application server 105 decrypts the data that was encrypted in block 415 prior to sending the data back to the user. Application server 105 uses the second key 172 to decrypt this data in the account object. Application server 105 then finishes executing the remaining unmodified portion of original application code 140 as per block 350. This task being completed, the user request is satisfied and the process ends at block 355.

Returning to decision block 405, if block 405 determines that the user request is not to get data, then process flow continues to block 420 where the requested data is decrypted for sending back to the user and process flow continues as before.

Table 1 below shows a representative portion of original application code 140 prior to its modification to enable it to intercept requests for memory objects and to encrypt/decrypt memory objects. In this particular example the organization hosting application server 105 is a bank or credit union. The variable, Account, represents an account number which is different for each user. Account numbers are stored in application server 110 or database 160 as memory objects. The variable, Transactions, represents data or information with respect to each transaction that is conducted. The variable CurrentBalance represents the money balance in a particular account. It is noted that the sample code of Table 1 includes both set operations that write to stored memory objects and get operations that read from stored memory objects. The memory objects employed by the code in Table 1 are not encrypted at this point.

TABLE 1

try {

Account a = Account.getAccount(12);
return a.getCurrentBalance( );

}
try {

Account a = new Account(30);
a.setName(“smith”);

}
try {

Account a = Account.getAccount(30);
List txns = a.getTransactions( );
while (txns.next( )) {

... display txn ...

Table 2 below represents the original application code 140 after it is modified to become the instrumented code with secured proxy implementation (instrumented code) 170. As seen below the original code is modified so that when the code makes a call or executes a get operation to obtain the account balance, rather than accessing the Account Balance directly, the request for the Account Balance is intercepted by instrumented code 170. Secure proxy 155 then encrypts the Account Balance by using the second key 172 of key pair 107 associated with the verified user. Secure proxy versions of the variables are employed in the code of Table 2. Secure proxy 155 then uses the first key provided in request 107 in conjunction with the second key obtained from database 160 to decrypt requested memory objects. In comparing the representative modified code 170 of Table 2 with the original application code 140 of Table 1, it is seen that the variable or memory object Account is replaced by a secure proxy version thereof, namely AccountSP. Secure proxy implementation 165 injects and weaves code into original application code 140 to form modified code 170, namely the instrumented code with secure proxy (SP) implementation.

TABLE 2

try {

AccountSP a = AccountSP.getAccount(12, cert);
return a.getCurrentBalance(cert);

}
try {

AccountSP a = new AccountSP(30, cert);
a.setName(“Jones”, cert);

}
try {

AccountSP a = AccountSP.getAccount(30,cert);
List txns = a.getTransactions(cert);
while (txns.next( )) {

... display txn ...

In the example of Table 2 above, secure proxy layer 155 provides an interface into the encrypted Account objects of encrypted objects 150. AccountSP represents the encrypted Account object. If somehow an unverified user were to accidentally achieve access to the encrypted Account object, namely Account SP, that person would see scrambled information since that object is encrypted. Application server 105 encrypts any parameters or variables passing through secure proxy layer 155 with the first key 171 that is associated with the verified user of that information. Secure proxy 155 uses the second key 172 of the verified user's key pair to decrypt that user's encrypted information. In one embodiment, secure proxy 155 performs encryption on objects that are sensitive while leaving non-sensitive objects unencrypted. Secure proxy layer 155 encrypts any set methods, or information writes, with the user's first key if those set methods involve sensitive information. When application server 105 calls a get method in response to a user request for information, the get method compares the digital signature associated with user request 107 with the user's digital signature in application server 105. If the digital signature of the user request matches the stored digital signature associated with the requested information and its authorized user, then application server 105 uses the second key 172 of the key pair 170 associated with the user making the request to decrypt the requested information, namely the requested encrypted object, to satisfy the get. Application server 105 returns a local copy of the object including the decrypted requested information to a caller while the original data in the encrypted object remains encrypted in that object. If a method that is not a get/set is called when processor 125 executes code, application server 105 compares the digital signature of the requesting user against the digital certificate associated with the relevant encrypted object to verify that the signatures match. This is done to assure that the method does not execute if the signatures fail to match.

Table 3 shows a representative information object prior to encryption in one embodiment of system 100. In this particular example, the objects are assumed to be information stored in an application server of a business organization wherein employees are the authorized users of the information. The employee users are all granted access to general non-sensitive information. However, each employee also has access to their own sensitive information that is restricted. For example one employee's sensitive information may include health benefits information or payroll information for that employee. Table 3 below shows a sample employee object.

TABLE 3

public class employee {

| | |
|---|---|
| int | employeeId; |
| String | lastName; |
| String | firstName; |

void setEmployeeId(int id) {

employeeId = id;

}
void setLastName(String ln) {

lastName = In;

}
void setFirstName (String fn) {

firstName = fn;

}
int getEmployeeID ( ) { return employeeId; }
String getFirstName ( ) { return firstName; }
String getLastName ( ) { return lastName; }

The variable employeeID is the employee's identification number. Strings lastName and firstName represent a particular employee's last and first name respectively in the representative object of Table 3. Since this object contains sensitive information, secure proxy layer 155 encrypts the object when an operation or method involving this object commences. In other words, whenever instrumented code 170 attempts a set or get on a sensitive memory object, the requested information is encrypted by secure proxy layer 155. The proxy 155 for this employee object intercepts this object or class and injects both set and get methods into the original application code 140 to enable the modified code to encrypt/decrypt the data as instructed by the secure proxy implementation 165. Application server 105 thus forms the modified code, namely instrumented code 170, and provides the modified code with encrypt/decrypt capabiity.

Class loader 157 controls the time at which original application code 140 is modified. Class loader 157 modifies the original application code when the code needs to load a class object into system memory 135 from non-volatile storage 130, for example a disk drive. Typically, this occurs when application server 105 first calls the original application code 140. In one example, the original application code is a Java archive (JAR) file named code.jar and the code.jar file includes the following classes: InitializeApplication.class and Employee.class. Since the application code initializes InitializeApplication.class when the application starts, the InitializeApplication.class is loaded by processor 125 when InitializeApplication.class is first called. However, application server 105 may not call the Employee.class until much later when users start using the application code. Thus, the Employee.class will load and be modified at whatever time the application code calls the Employee.class.

in an alternative embodiment, the particular application on user system 110 that submits a request for information need not be a browser such as browser 120. Rather, instead of browser 120, a fat client such as Lotus Notes or Microsoft Outlook or other client-server application can submit the request for information to application server 105. In yet another embodiment, rather than associating a permanent first key-second key pair with a particular user, application server 105 assigns a new user key pair to each user whenever the user logs onto application server 105 and is verified by the secure proxy layer 155 of application server 105. In such an embodiment, application server 105 stores a large number of unique first key second key pairs in database 160 to provide a large population of key pairs that can be assigned to particular users when they log onto the application server and are verified thereby. A one-time use key pair embodiment is thus provided.

Those skilled in the art will appreciate that the various structures disclosed, such as list of sensitive objects 163, database 160, secure proxies 155 and other structures can be implemented in hardware or software. Moreover, the methodology represented by the blocks of the flowcharts of FIGS. 2, 3 and 4 may be embodied in a computer program product, such as a media disk, media drive or other storage media.

In one embodiment, the disclosed methodology is implemented as a server application, namely a set of instructions (program code) in a code module which may, for example, be resident in the system memory 135 of application server 105 of FIG. 1. Until required by application server 105, the set of instructions may be stored in another memory, for example, non-volatile storage 130 such as a hard disk drive, or in a removable memory such as an optical disk or floppy disk, or downloaded via the Internet or other computer network. Thus, the disclosed methodology may be implemented in a computer program product for use in a computer such as application server 105. It is noted that in such a software embodiment, code which carries out the functions described in the flowcharts of FIGS. 3 and 4 may be stored in RAM or system memory 135 while such code is being executed. In addition, although the various methods described are conveniently implemented in a general purpose computer selectively activated or reconfigured by software, one of ordinary skill in the art would also recognize that such methods may be carried out in hardware, in firmware, or in more specialized apparatus constructed to perform the required method steps. Moreover the client functions described in the flowchart of FIG. 2 can similarly be resident as a code module in a system memory (not shown) of user system 110. Alternatively such a client code module may be embodied in a computer program product, such as a media disk, media drive or other storage media.

A client-server network system is thus provided that protects memory data objects from being viewed by other than a verified user. Instrumented code with a secure proxy implementation (modified code) intercepts a call to an original class object via a secure proxy that is injected or weaved into original application code. The secure proxy mediates control of, and encryption/decryption of, the original class object. In this manner, an existing software application can be secured without rewriting the code of the application. Moreover the application code is modified automatically by the secure proxy implementation while the application code is “in situ” on the application server. There is no need to move the code to another location to implement this enhanced security measure. Attempts to access the object without using the secure proxy fail because the object is encrypted with the first key of the user.

Modifications and alternative embodiments of this invention will be apparent to those skilled in the art in view of this description of the invention. Accordingly, this description teaches those skilled in the art the manner of carrying out the invention and is intended to be construed as illustrative only. The forms of the invention shown and described constitute the present embodiments. Persons skilled in the art may make various changes in the shape, size and arrangement of parts. For example, persons skilled in the art may substitute equivalent elements for the elements illustrated and described here. Moreover, persons skilled in the art after having the benefit of this description of the invention may use certain features of the invention independently of the use of other features, without departing from the scope of the invention.

What is claimed is:

1. A method of controlling access to information in a server system comprising:
storing original application code in a server system including a shared resource;
modifying the original application code to intercept user requests for a memory object derived from information in the shared resource, thus providing modified code;
receiving a user request for access to the memory object;
verifying that the user request is from a user with authority to access the memory object; and
accessing and encrypting the memory object requested by the user request if the user is verified, thus providing an encrypted memory object.

2. The method of claim 1 further comprising decrypting the encrypted memory object if the user is verified, thus providing a decrypted memory object.

3. The method of claim 2 further comprising transmitting information in the decrypted memory object to the verified user.

4. The method of claim 1 wherein verifying the user is performed by a secure proxy.

5. The method of claim 1 wherein accessing and encrypting is performed by a secure proxy.

6. The method of claim 1 wherein receiving a user request further comprises receiving a user request including a unique identifier.

7. The method of claim 6 wherein the unique identifier is a digital signature.

8. The method claim 6 wherein the unique identifier is a user name.

9. The method of claim 2 wherein the decrypting is performed by a secure proxy.

10. The method of claim 1 wherein the original application code is written in an aspect oriented programming language.

11. The method of claim 1 wherein the encrypting is performed using a key pair including first and second keys, one key of which is provided to the server system by a verified user.

12. A server apparatus comprising:
a storage that stores original application code and modified application code, the original application code being modified to intercept user requests for a memory object derived from information in a shared resource, thus providing modified application code which is capable of:
receiving a user request for access to the memory object;
verifying that the user request is from a user with authority to access the memory object; and
accessing and encrypting the memory object requested by the user request if the user is verified.

13. The server apparatus of claim 12 further comprising a secure proxy, situated in the storage, that performs the accessing and encrypting of the memory object, thus providing an encrypted memory object.

14. The server apparatus of claim 13 wherein the verifying is performed by the secure proxy.

15. The server apparatus of claim 14 wherein the secure proxy decrypts the encrypted memory object if the user requesting the encrypted memory object is verified.

16. The server apparatus of claim 14 wherein the user request includes a unique identifier.

17. The server apparatus of claim 16 wherein the unique identifier is a digital signature.

18. The server apparatus claim 16 wherein the unique identifier is a user name.

19. A computer program product stored on a computer operable medium for controlling access to information in a server system, the computer program product comprising:
means for storing original application code in a server system including a shared resource;
means for modifying the original application code to intercept user requests for a memory object derived from information in the shared resource, thus providing modified code;
means for receiving a user request for access to the memory object;
means for verifying that the user request is from a user with authority to access the memory object; and
means for accessing and encrypting the memory object requested by the user request if the user is verified.

20. The computer program product of claim 19 further comprising decrypting the encrypted memory object if the user is verified.
